(19) United States
(12) Patent Application Publication
(10) Pub. No.: US 2016/0239608 A1
(43) Pub. Date: Aug. 18, 2016

(54) ARRANGEMENT AND A METHOD FOR CREATING A SYNTHESIS FROM NUMERICAL DATA AND TEXTUAL INFORMATION

(71) Applicant: VIVAGO OY, Espoo (FI)

(72) Inventors: Eelis CEDERSTROM, Helsinki (FI); Sami OITTINEN, Espoo (FI); Anna Kaisa KYLMA, Helsinki (FI)

(21) Appl. No.: 15/137,369

(22) Filed: Apr. 25, 2016

Related U.S. Application Data
(63) Continuation-in-part of application No. 14/483,433, filed on Sep. 11, 2014.

(30) Foreign Application Priority Data
Sep. 13, 2013 (GB) 1316286.2

(51) Int. Cl. G06F 19/00; G06F 17/28

(52) U.S. Cl. CPC G06F 19/322; G06F 19/3406; G06F 17/28

(57) ABSTRACT

Disclosed is a system for creating a synthesis from numerical data and textual information relating to wellbeing of an individual, including: a control entity including a processor, a memory coupled to the processor and at least a unit for obtaining and providing data, the control entity being further arranged to: obtain first data including numerical information from at least one wellbeing device, which device is arranged to monitor the individual's at least one wellbeing characteristic, obtain second data including free-form text in natural language format information, the information pertaining to the individual, execute semantic analysis for the obtained second data including free-form text, create a synthesis from the first data and the semantically analyzed second data, compare at least the values of wellbeing characteristic in the first data or second data to predetermined threshold values or to a previously determined synthesis. Corresponding method and computer implemented program are also presented.

### TECHNICAL FIELD

Generally, the invention relates to a system and a method for creating a synthesis from numerical data and textual information, and more particularly, the invention relates to a system and a method for creating a synthesis from numerical data and textual information relating to wellbeing of an individual.

### BACKGROUND TECHNOLOGY

In recent century, life expectancy for humans in developed nations has rapidly increased and people are also staying healthy to a more advanced age. Though, many elderly people want to live in their own home as long as possible, aging itself brings changes to a health and this is why several elderly people may fall into home health care services.

Various types of home care services are municipally and commercially provided, such as custodial care helping with daily living activities comprising meal, bathing, laundry, cleaning, shopping, and safety service; health care services giving medical care, such as medication management, wound care, administration of injections and IVs, blood draws, ventilation and respiratory care and fall prevention assessments, just to name a few tasks. For home care service personnel, it is essential task to notice signs in a client that may tell about weakened health condition, injuries, outbreak or worsening of diseases, such as diabetes, MS or dementia.

Unfortunately, due to the lack of municipal resources, especially, home care service personnel can have a vast number of clients and, normally, each caregiver has way too little time to be familiarized with each client's situation and health care history. During a normal day at work, one caregiver may meet several new clients for the first time, and while having a tight schedule, may have only few minutes to get relevant information concerning each client, such as read his/hers medical history or other caregivers comments. The client itself may even mislead the caregiver by leaving out important facts relating to his/hers wellbeing or by belittling his/hers symptoms. In case of a memory disorder, the client may not even be able to tell relevant issues to the caregiver. Obviously, lack of knowledge or delayed response to alarming signs in client's condition may lead the client, who lives at home, to a serious situation or it may delay beginning of disease treatment.

### SUMMARY OF THE INVENTION

It is an object of the present invention to implement such a solution, that previously mentioned drawbacks of the prior art could be diminished. In particular, the invention is implied to solve how up-to-date and relevant information from various sources can be gathered and provide to a caregiver in an easily understandable form.

The objective of the invention is met by the features disclosed in the independent patent claims.

A system for creating a synthesis from numerical data and textual information relating to wellbeing of an individual according to an aspect of the present invention is characterized by the features of claim 1.

According to an embodiment of the invention, a computer implemented system for creating a synthesis from numerical data and textual information relating to wellbeing of an individual comprising:
a control entity comprising a processing device, a memory device coupled to said processing device and at least means for obtaining and providing data, the control entity being further arranged to:
   obtain first data comprising numerical information from at least one wellbeing device, which device is arranged to monitor said individual's at least one wellbeing characteristic,
   obtain second data comprising free-form text in natural language format information, said information pertaining to the individual,
   execute semantic analysis for the obtained second data comprising free-form text,
   create a synthesis from said first data and the semantically analyzed second data,
   compare at least the values of wellbeing characteristic in the first data or second data to predetermined threshold values or to a previously determined synthesis, optionally to determine a trend of said characteristics values,
   generate an alarm if the generated synthesis comprises a number of wellbeing characteristics whose values are outside predetermined threshold values or outside previously determined synthesis values and/or if the trend of said characteristic values changes.

The wellbeing characteristics may comprise weight, any type of heart rate, movement per time, blood pressure, caloric intake, SpO2, sleep cycles and quality thereof, blood sugar, and trends thereof, etc. Being outside of typical values for these characteristics (known from the prior art of medical sciences) may imply various different conditions. Hence, a number of (different) characteristics may be determined to determine trends and alarm(s), optionally simultaneously since in many cases a plurality of characteristics are needed for making even an initial diagnosis. Various devices that produce also other sensor data pertaining to various other wellbeing characteristics may be used.

The first data comprising numerical information is preferably provided by a wellbeing device, which is arranged to monitor said individual's wellbeing. This feature is advantageous, because typically, wellbeing devices, which are arranged to monitor several things, such as the user's activity and circadian rhythm, can be worn long periods of time, which provides a lot of data. In addition, the health condition of the user and, especially, changes in the condition may be noticed by means of the wellbeing devices, which makes them valuable aid in everyday health monitoring. Most of the wellbeing devices comprise an alarm function, which can alarm or provide means to the user to alarm help in case of an emergency, such as falling.

In accordance with an exemplary embodiment the second data comprising textual information is provided by a user, such as a caregiver, doctor, relative, guardian, the client themself or other such personnel. Any kind of caregiver providing help to the client typically writes a summary for other caregivers and/or her/himself about the visit comprising e.g. what has been done and comments about the client's condition, especially in situation, where the client is an elderly person living home alone and/or having a trauma, disability and/or disease. Respectively, caregivers coming to visit the client would preferably read comments written by other caregivers in order to gain relevant information about the client's overall situation.

In another embodiment, the system according to the present invention further comprises obtaining third data from one or more external measurement devices, which third data is also used in creating the synthesis. In case of an elder people, various kinds of measurement devices may be used daily and/or weekly providing information about the client's health, such as a scale, a body composition measurement device, a heart rate monitor, a pedometer, a blood measurement device, a blood glucose meter, sleep tracking means, a spirometer, an alcometer, a breathalyzer, EEG (Electroencephalography) and ECG (Electrocardiography). Hence, the third data may comprise information in a myriad of numerical forms and in some cases also textual form.

Yet, in another embodiment, the system according to the present invention further comprises obtaining fourth data from one or more external databases, which fourth data is also used in creating the synthesis. This feature is advantageous, because typically various authorities and private operator can have interesting information relating to the client, which can be included in the obtained information in order to create a synthesis. As well, the other data obtained and/or processed by the arrangement according to the present invention can be further transferred to one or more external databases.

Yet, in another embodiment, the synthesis provided by the arrangement according to the present invention is provided at least partially in a textual form. In accordance with another embodiment of the present invention the synthesis and/or alarm are provided via user interface (UI) means. In yet another embodiment the synthesis comprises a reason for the alarm and/or implementable actions according to the reason of the alarm. The reason may be in particular an underlying condition or proposed diagnosis pertaining to a change in a wellbeing characteristic in any data in accordance with the comparison to a number of predetermined threshold values, previously determined synthesis, or trend.

A computer implemented method for creating a synthesis from numerical data and textual information according to an aspect of the present invention is characterized by the features of claim 8.

According to an embodiment of the invention, a computer implemented method for creating a synthesis from numerical data and textual information, comprising at least the following steps:
obtaining data in a numerical form,
obtaining data comprising free-form text in natural language format,
converting the data in a numerical form into a textual form,
semantically analyzing and/or formalizing said free-form text in natural language format,
creating a synthesis from said data in a numerical form and said semantically analyzed and/or formalized free-form text in natural language format,
providing said synthesis to a user and/or a device.

In another embodiment, the method according to the present invention comprises a further step of selecting a time period for obtained data and information. This feature is advantageous, because it enables creation of a synthesis for different purposes. For example, a nurse may benefit of a synthesis from the past two weeks, whereas the synthesis from past year may provide a wide insight into the overall situation of the client.

In accordance with an aspect of the present invention a computer program product embodied in a non-transitory computer readable carrier or distribution medium comprising computer instructions that, when run on a computer, cause the computer to execute the method in accordance with the present invention.

Some preferable embodiments of the invention are described in the dependent claims.

Significant advantages can be achieved with the present invention when compared to the prior art solution. The arrangement and the method for creating a synthesis may provide for caregivers an easy and effective way to gather and produce relevant information relating to a client's condition, changes in health, circadian rhythm and activity. The invention can be arranged to gather information from different sources and to form it into a one entity, which may be clear and easily readable.

In addition, the invention may efficiently perform health condition monitoring of the client and it may help caregiver to notice alarming signs in client's health and/or condition and, in that way, to prevent the emergence of serious situations and/or accidents.

Furthermore, the present invention may be efficient for detecting and bringing forth weak signals, i.e. first signs of forthcoming chance relating to a client's wellbeing and/or health. Both short-term and long-term trends in input topics and optionally in related responsive actions may also be inspected.

The previously presented considerations concerning the various embodiments of the system may be flexibly applied to the embodiments of the method and of the computer program product mutatis mutandis and vice versa, as being appreciated by a skilled person. Similarly, the provision and utilization of the system, method and computer program product are scalable in the limitations of the entities according to the system.

In the present document, the term “client”, hereafter also referred as “individual”, refers to a person typically living at home or a homelike environment, whose wellbeing is monitored by using one or more appropriate monitoring means, such as a wellbeing device, and who has any kind of professional and/or unprofessional home care service relating to his/her wellbeing and/or health.

In the present document, the term “wellbeing” may refer to several monitored vital signs or other monitorable variable/variables, such as, but not limited to, activity, sleep detection and circadian rhythm, relating to wellbeing of an individual or indicating chances in individual's health.

Further, in the present document, the term “caregiver” refers to at least one person of home care service personnel, which can be professional, such as, but not limited to, nurses, home care aides, social workers, physical therapists, occupational therapists, speech and language pathologists and dietitians, or an unprofessional person aiding with daily living activities or for keeping company, for example.

The expression “numerical form” refers herein to any kind of value, which can be measured and/or compared to other values, as numbers, decimal numbers, integers, binary numbers, rational numbers, and irrational numbers.

The expression “electronic text” refers herein various electronic formats comprising text, such as a Word file, text file, Portable Document Format file or another suitable text file format.

The expression “textual form” refers herein, in a more general sense, words in a meaningful order to convey information. The textual form can comprise electronic text as described above and/or text in a paper.

The term “information” refers herein, in most cases, to information comprised in a data format or information provided visually via UI or textual means, such as printed on a paper.

The terms “alarm” and “alert” are used interchangeably and refer to a visually, audibly, or audiovisually provided signal and/or underlying basis thereof.

The term “exemplary” refers herein to an example or example-like feature, not the sole or only preferable option.

The expression “a number of” refers herein to any positive integer starting from one (1), e.g. to one, two, or three, whereas the term “a plurality of” is used to refer to any similarly to any positive integer but starting from two (2).

The term “arrangement” is herein used interchangeably with the term “system”. However, the actual meaning and object of both terms must be construed in accordance with the proper context.

The terms “a” and “an”, as used herein, are defined as one or more than one.

### SHORT DESCRIPTION OF THE DRAWINGS

Next, the invention is described in more detail with reference to the appended drawings, in which

FIG. 1 illustrates the concept of an embodiment of the system in accordance with the present invention;

FIG. 2 illustrates internals of an embodiment of a control entity in accordance with the present invention;

FIG. 3 illustrates a conceptual depiction of an embodiment of the system in accordance with the present invention;

FIG. 4 is a flowchart of an embodiment for creating the synthesis in accordance with the present invention;

FIG. 5 is a flowchart of an embodiment for creating the alarm in accordance with the present invention;

FIG. 6 is an illustration of a graphical user interface implemented embodiment of a synthesis and alarm thereof in accordance with the present invention.

### DETAILED DESCRIPTION OF THE EMBODIMENTS

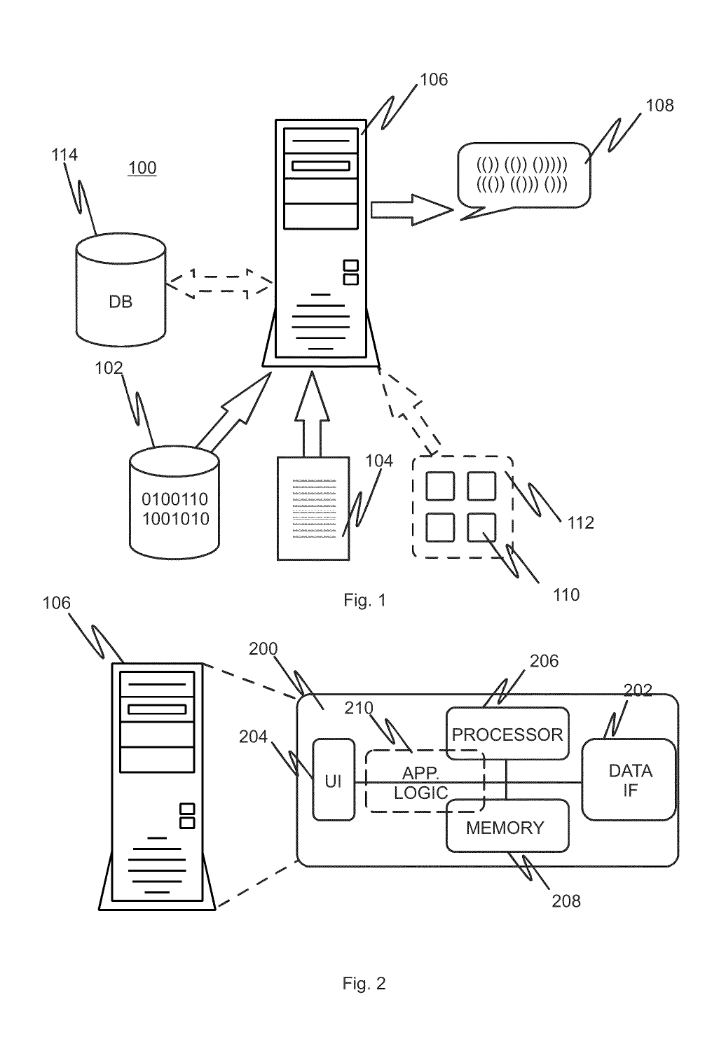

FIG. 1 illustrates the concept of an embodiment of the present invention. In one embodiment, a system 100 for creating a synthesis 108 from numerical data and textual information relating to wellbeing of an individual comprises a first information 102, a second information 104 and an control entity 106.

In a preferred embodiment, the first information 102 is in a numerical form. In another embodiment, the first information 102 can also comprise data in another form, such as a graphical form. In one embodiment, the first information relating to wellbeing of an individual is provided by a wellbeing device, which is arranged to monitor the individual's wellbeing. Such wellbeing devices may include one or more wearable devices, e.g. a wrist-held device, arranged to monitor user's wellbeing, such as activity, steps, movement and type of movement, sleep and circadian rhythm. Typically, the circadian rhythm can be deduced based on the activity and sleep detection data. It is obvious to the person skilled in the art, that the wellbeing device can also be arranged to monitor other vital signs, such as, but not limited to, heart rate, body temperature, blood pressure and respiratory rate.

In another embodiment, the wellbeing device is also arranged to monitor other issues, such as wearing/not wearing, on/off and in range/ out of range. These data information, as well as other monitored information, can be included in wellbeing device's data related to individual's wellbeing.

Yet, in another embodiment, the wellbeing device can be arranged to monitor and transfer other information relating to the device itself, such as battery state of charge, the temperature of the initials of the device and total usage time, to name a few.

Preferably, the wellbeing device is arranged to transfer data to a base unit, such as, but not limited to, cloud, a server, a computer, a laptop, a tablet, a smartphone, another mobile device or the combination thereof. It is obvious to the person in the art that the base unit can also locate in the control entity of the present invention or the base unit can be arranged to be a part of the control entity.

In a preferred embodiment, the second information 104 comprises free-form text in natural language format and it can be an electronic text or it can be converted into an electronic text. The person skilled in the art will understand that free-form text, when provided as an electronic text, can comprise a number of text files in one or more formats comprising also metadata.

In a preferable embodiment, both the first and the second information comprise a time stamp or other time information relating to the origin of the information. In another embodiment, the creation time or time span can be traced by some other means. In another embodiment, also a third information comprises time information relating to the origin of the information.

In one embodiment, the second information is provided by caregiver personnel. The second information can be provided into the arrangement by various means, e.g. by typing it by using of a communication interface of an electronic device, such as, but not limited to, a computer, a mobile phone, a smart phone a laptop or a tablet, to name a few. In another embodiment, speech recording is used in connection with some speech recognition software, which is arranged to convert the recorded speech into an electronic text in some suitable text format. In another embodiment, hand written text and/or text written with a typewriter is scanned with optical character recognition by some suitable software. The person skilled in the art will understand that the arrangement can be arranged to obtain the second information by using different embodiments and above described embodiments can be combined in order to provide second information in an electronic text format. It is also obvious to the person skilled in the art that the second information provided as an electronic text in an electronic device can be transferred to the control entity, if the electronic device in question is not the control entity or a part of it.

In one embodiment, the arrangement further comprises one or more external measurement devices 110 arranged to provide a third information 112, which third information 112 is obtained by the control entity of the present invention and included in the obtained information for creating a synthesis 108. The group of external measurement devices is depicted with a dotted line in FIG. 1 to indicate the optional or additional characteristic of this embodiment.

The group of external measurement devices 110 can comprise various kinds of measurement devices, such as, but not limited to, a scale, a body composition measurement device, a heart rate monitor, a pedometer, a blood measurement device, a blood glucose meter, sleep tracking means, a spirometer, an alcometer, a breathalyzer, EEG (Electroencephalography) and ECG (Electrocardiography). The person skilled in the art will understand that various types of external device/devices can be included in or exclude from the group of external measurement devices.

The third information provided by the external measurement devises 110 can be in a numerical form, in a textual form, in a graphical form or any kind of combination thereof. Depending on a device in the group of the external devices 110, the device can comprise wireless and/wired means for transferring data, such as Bluetooth, Wibree, ZigBee or USB. The data transfer between the external measurement devices and the control entity 106 can be arranged to be straight and/or automatic performed or the data can be first transferred via another electronic device, such as the base unit of the wellbeing device.

Yet, in another embodiment, the arrangement further comprises one or more external databases 114 arranged to provide a fourth information, which fourth information is obtained by the control entity of the present invention and included in the obtained information for creating a synthesis 108. The external database 114 is depicted with a dotted line in FIG. 1 to indicate the optional or additional characteristic of this embodiment.

The external database(s) can comprise data from various sources, such as, but not limited to, information provided by a wellbeing service and/or another wellbeing arrangement, health information, medical reports, anamneses, diagnoses and/or medical case summaries provided by authorities responsible of healthcare and/or private healthcare clinics and/or hospitals. The other database(s) can locate in one or more places, such as in cloud, in one or more servers and/or computer(s) and/or in another electronic device(s). The fourth data can be obtained from the external database(s) via wireless and/or wired means.

The fourth information can also comprise information relating to enterprise resource planning. It is obvious to the skilled person that the fourth information obtained from the external database(s) can be other information relating to the individual in question. The fourth data is can be in a numerical form, in a textual form, in a graphical form or any kind of combination thereof.

The fourth data is obtained from the external database(s) 114, but, as indicated with a double-headed arrow, another data, such as a synthesis 108, syntheses, the first information, the second information, the third information and/or the fourth information from another databases or any combination thereof, can also be transferred to the external database.

It is obvious to the skilled person that the previous described embodiments can be combined in various different ways when creating a synthesis 108.

In one embodiment, the first, the second, the third and/or fourth information comprises time information relating to the origin of the data. The time information is used to arranging the information in chronological order. In one embodiment, the user can select the time period for the obtained information. The feature is advantageous, because various types of synthesis 108 can be created for different purposes. For example, a nurse may consider a synthesis 108 based on the last two weeks period of data to be the most useful for his/her purposes. When observing the situation and development of the individual on the whole, the synthesis 108 from a wider time period, such as six month, a year or even wider than that, may be useful.

In another embodiment, the all obtained and saved information is utilized when creating a synthesis 108. In one embodiment, the certain data contribution can be emphasized by giving it a higher weight. In one embodiment, more recent data gets a higher weight than older data. In another embodiment, data is weighted based on the source of the data. In an example of the present embodiment, the first information is weighted with a higher coefficient than the second information. In another example, the second information provided by a nurse gets a higher weight coefficient than the second information provided by a relative, for instance.

It is obvious to the person skilled in the art, that the above described embodiments can be combined, in other words, it is possible to provide an arrangement, which provides a synthesis creation from a selectable time period and weighing data with different coefficients based on various criteria.

The control entity 106 according to the present invention is arranged to obtain and process the first information 102, the second information 104, and, optionally or additionally, the third information 112 and/or the fourth information. The control entity 106 may be implemented with a number of computing devices, such as servers and/or general computer devices, and it may at least partially reside in a cloud computing environment from which computational resources may be flexibly allocated upon need. It is obvious to the skilled person that the components of the control entity do not have to locate in the same place, but those components can be functionally connected with each other.

Further, for clarity it should be noted that the primary function of the arrangement 100 is to create a synthesis 108 from a number of data components collected from any of the aforementioned devices, the devices may be also included in the system. Therein the system includes, in addition to obtaining data from the first, second, third and fourth devices, the system also includes those devices.

In FIG. 2 is presented, by way of example only, a block diagram of internals 200 of the control entity 106. The control entity 106 comprises data interface and/or transfer means 202 for obtaining and providing data, such as an API (Application programming interface) and/or at least one transceiver incorporating e.g. a radio part including a wireless transceiver, such as WLAN (wireless LAN), Bluetooth or a cellular like GSM (Global System for Mobile Communications)/UMTS (Universal Mobile Telecommunication System) transceiver and/or other wireless or wired data connectivity means such as one or more wired interfaces (e.g. Firewire, LAN such as Ethernet, or USB (Universal Serial Bus)) for obtaining the first, the second and, optionally, the third information, and general communications with external devices and/or a network infrastructure.

The UI (user interface) 204 may comprise data visualization element, such as a display, e.g. an (O)LED (organic LED) or LCD (liquid crystal display) display, and/or a connector to an external display, a printer or a plotter, and a data input element, such as a keyboard/keypad/mouse/touchpad and/or other applicable control input means (e.g. a touch screen or voice control input system, or separate keys/buttons/knobs/switches) configured to provide the user of the control entity 106 with practicable data, visualization means and control, such as typing and/or editing means. The UI 204 may further include one or more loudspeakers and associated circuitry such as D/A (digital-to-analogue) converter(s) for sound output, and a microphone with A/D converter for sound input.

Furthermore, the control entity 106 comprises one or more processing devices 206 capable of processing instructions and other data, such as one or more microprocessors, microcontrollers, DSPs (digital signal processor), programmable logic chips, or a desired plurality of any of those. The processing entity 206 may thus, as a functional entity, physically comprise a plurality of mutually co-operating processors and/or a number of sub-processors connected to a central processing unit, for instance. The processing entity 206 may be configured to execute the code stored in a memory 208, which may refer to analysis software 210 in accordance with the present invention and other desired software applications.

Similarly, the memory entity 208 may be divided between one or more physical memory chips or other memory elements. The memory 208 may be configured to accommodate a computer program comprising code elements in the form of computer-executable instructions and related other data for controlling the arrangement. Further, the memory 208 may be utilized to host the first information 102, the second information 104 and, depending on embodiment, the third information 112, as well as results of the arrangement 100, i.e. the synthesis 108 and possible intermediate results. The computer program may be embodied on a carrier medium, such as a memory card or an optical disc. The memory 208 may further refer to and include other storage media, such as a preferably detachable memory card, a floppy disc, a CD-ROM, or a fixed storage medium such as a hard drive. The memory 204 may be non-volatile, e.g. ROM (read only memory), and/or volatile, e.g. RAM (random access memory), by nature.

The logic for the analysis engine and the related functionalities may indeed be implemented as software stored in the memory entity 208 and executed by the processing entity 206. The analysis entity 210 may include a number of applications, modules, and/or other software preferably having a functional interconnection. Software 210 may utilize a dedicated or a shared processor for executing the tasks thereof.

In a preferred embodiment, the natural language processing entity can be configured to semantically analyze the free-form text in natural language format by executing one or more various analyzing methods, such as, but not limited to, classification, filtering, language identification, segmentation, tokenization, morphological analysis, named entity recognition, syntactic analysis, parsing, topic detection, and sentiment analysis.

Still in a further, either supplementary or alternative, embodiment, the natural language processing entity comprises or is at least functionally connected to a database such as a knowledgebase, or other entity, including a basic logic entity common to a plurality of natural languages supported by the arrangement and a language-specific language model and/or other language-specific definition(s) incorporating e.g. at least part of associated grammar, a vocabulary/dictionary, and/or a number of common phrases.

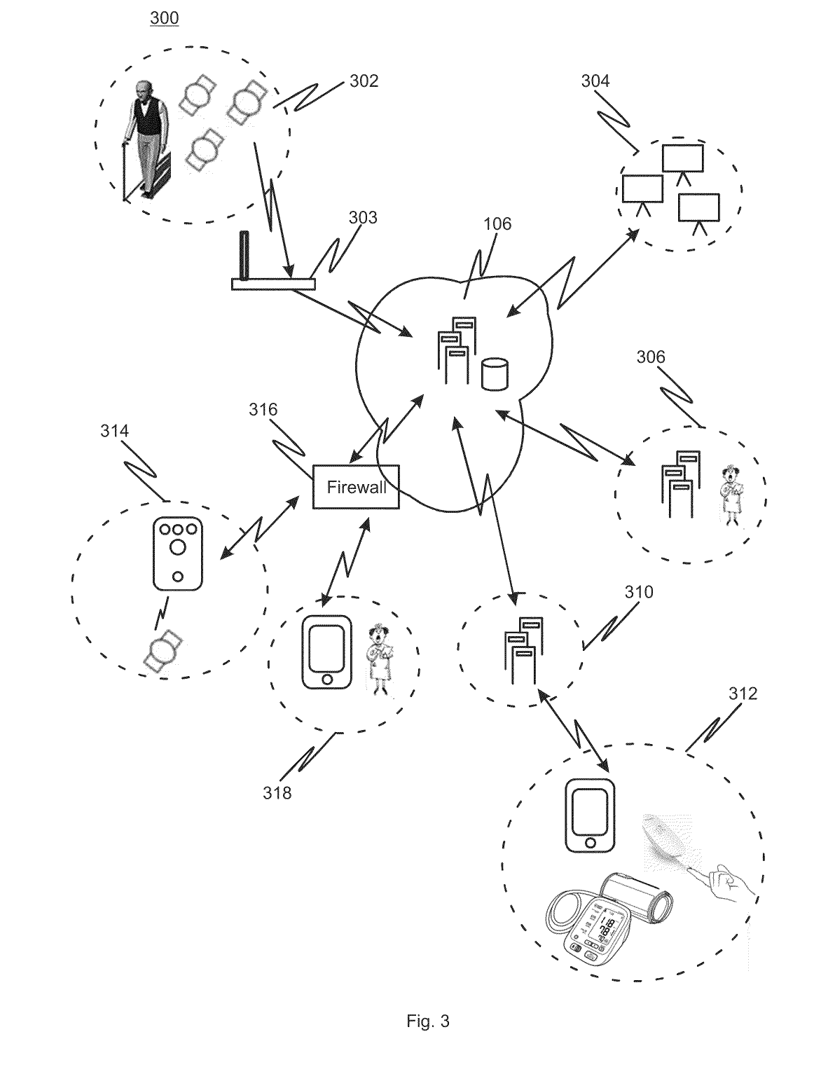

FIG. 3 illustrates a conceptual depiction of an embodiment of the system in accordance with the present invention.

The system 300 illustrates some preferable as well as optional parties, devices, applications and communication arrangements feasible for the system 300. Herein the control entity 106 is implemented in a cloud, or at least comprises cloud implemented services and/or processing.

The system may further comprise wellbeing and/or monitoring devices 302 worn and/or used by persons that provide sensor information, such as first or third data, via a router 303 to the control entity 106. A myriad of devices may be used as has been presented hereinbefore, which devices may comprise IoT (Internet of things) capabilities and functionalities.

The system 300 may also comprise an ODBC (Open Database Connectivity) means 304 for accessing or implementing DBMS (database management systems) and other feasible data sources. Further the system may comprise or utilize ERP (Enterprise Resource Planning) sources 306.

Further, the system 300 may utilize third parties 310 for accessing and/or implementing the system functions to third party devices 312 and/or data thereof.

Further, remote emergency and alert systems 314 may be utilized to collect information via a firewall 316. Even further, the synthesis created by at least part of the parties, devices and or sources mentioned hereinbefore may be provided via a firewall 316 to a device and a user thereof 318. More importantly the alarm generated on the basis of the synthesis may be automatically given to a device 318 so that a caretaker or such user may react and provide a person to which the synthesis and alarm pertain to, care, first-aid, medication, or any such actions that may be required.

The alarm may comprise implementable actions or information of the basis of the alarm, so that a user may see what the cause of the alarm is and act correspondingly. However, as mentioned the alarm may comprise implementable actions, such as textual information that a user needs CPR (Cardiopulmonary resuscitation) or any such treatment or care. However, these actions are known to a skilled in the art of first aid, physiatry and/or medical sciences and won't be detailed further. It is noted however, that the alarm needn't constitute or be given only exclusively in life-threatening situations. In many instances the alarm may be given to pre-emptively detect and act on symptoms and clues leading to heart attack, cerebral infarction, loss of consciousness, or even to slowly developing conditions, such as depression, obesity, diabetes, etc.

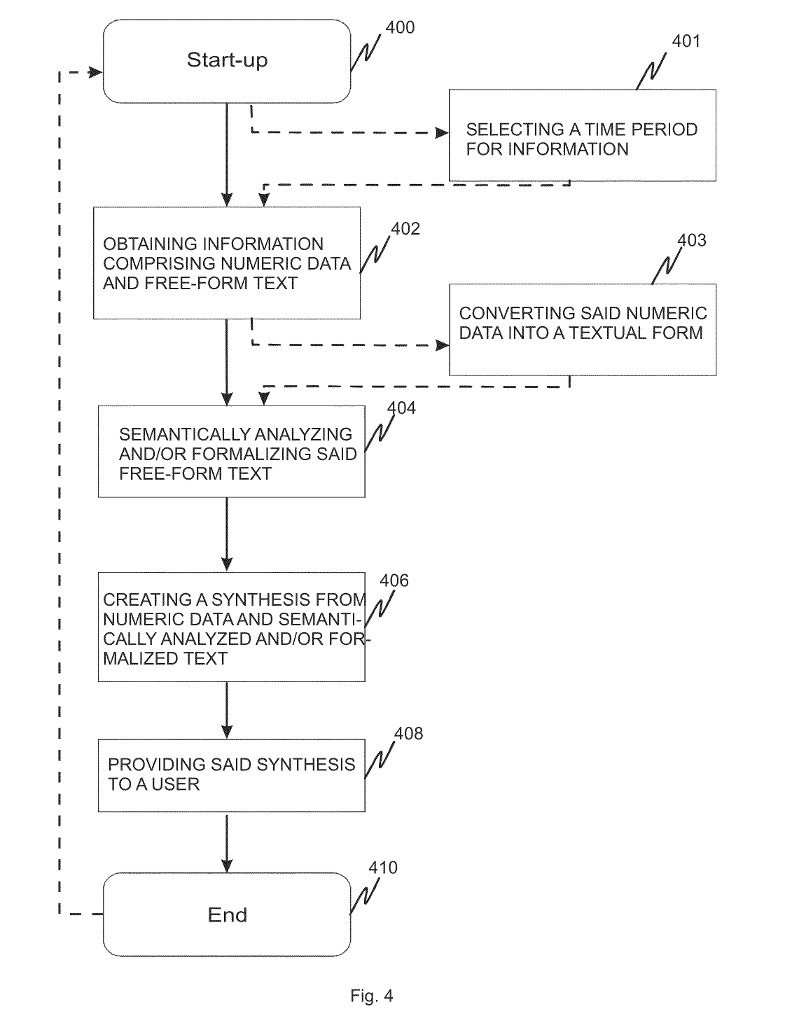

FIG. 4 discloses an exemplary flowchart for creating the synthesis in accordance with the present invention. The method may be executed by an embodiment of the system disclosed herein.

At step 400, the method is started. This step may comprise required installation and/or initialization procedures, such as obtaining and configuring related elements and executing related software.

At step 402, the information comprising data in a numerical form and free-form text in natural language format is obtained. Depending on embodiment, the first information, the second information and, optionally, the third information and/or the fourth information are obtained. It is obvious to the skilled person that the obtained information is preferably saved in the memory entity of the control entity for later use. In one embodiment, the user can select what data is included in the synthesis, i.e. data from one or more devices in the group of external measurement can be included or excluded.

In one embodiment, the method comprises step 401 before step 402, wherein a time period for information is selected. In one embodiment, at step 402, only that information falling within the selected time period is obtained, and in another embodiment all available information is obtained, but the information falling within the selected time period is included in the material, from which the synthesis is created. It is also possible to execute step 401 after step 402, in which case the time period affects to the information, from which the synthesis is created. In one embodiment, the user is able to select different time period for different information, i.e. the first information can comprise the past two weeks and the second information the past month.

In another, either supplementary or alternative, embodiment, the method comprises a step of selecting and/or editing data weighing criteria. This step can be performed before or after step 401, but it is preferably performed after step 402.

At step 403, data in a numerical form is converted into a textual form. In one embodiment, the data in a numerical form comprises the first information from a wellbeing device and/or data in a numerical form provided by one or more external measurement device. The arrangement can comprise a knowledgebase of the correspondence between the numerical data and their textual form. Depending on embodiment, the numerical data provide by a wellbeing device can have its own textual correspondence and, respectively, each of the external measurement device its own. In one embodiment, the database of the correspondence is loaded in the memory entity of the arrangement or in some other way pointed, where the processor entity is able to find it. In another embodiment, a new device included in the arrangement is identified and, based on its data type, a suitable common knowledgebase is used to converting the numerical data into a textual form.

However, it is obvious to the person skilled in the art that some data may remain in a numerical form. It is advantageous to present well-known information, such as blood sugar values in a numerical form. Anyhow, an explanatory text can still be added to the value in question.

At step 404, the obtained free-form text in natural language format is semantically analyzed and/or formalized. The semantic analyzing and/or formalizing is performed by executing one or more various analyzing methods, such as, but not limited to, classification, filtering, language identification, segmentation, tokenization, morphological analysis, named entity recognition, syntactic analysis, parsing, topic detection, and sentiment analysis. The purpose of this semantic analyzing and/or formalizing is to provide formalized and comparable information in a textual form relating to the individual's wellbeing. The skilled person will understand that other methods can also be used to analyzing and/or formalizing the obtained free-form text in natural language format.

At step 406, the synthesis is created from the semantically analyzed and/or formalized text and the numerical data, which is converted into a textual form. In another embodiment, also other data, such as data in a numerical form, is included in the information for creating the synthesis. Depending on embodiment, the synthesis is created for the selected time period. In one embodiment, the synthesis is created by analyzing similarities between data of different information sources, combining the information with each other and removing repeating parts of the information. In another embodiment, the information is further categorized depending on its type and significance. Yet, in another embodiment, alterations during the selected time period are observed, and in another embodiment, a minor issue/issues occurred in more than one data source is disclosed.

At step 408, the synthesis is provided to a user. In one embodiment, the synthesis is provided in a textual form, such as an electronic text comprising one or more text files, which can be in different types of formats. In another embodiment, the synthesis can also comprise another than textual information, such as data in a graphical form and/or numerical data.

The synthesis can be presented in one or more electronic device, such as, but not limited to, a computer, a laptop, a tablet, a smartphone or another mobile device. The synthesis can also be converted into a speech form and read out loud via loud-speaker and/or headphones. It is obvious to the skilled person that the synthesis can also be transferred elsewhere, e.g. in an e-mailbox. In addition, the synthesis is printable in a paper by using a printer, which can be a part of the arrangement or connected to some other electronic device.

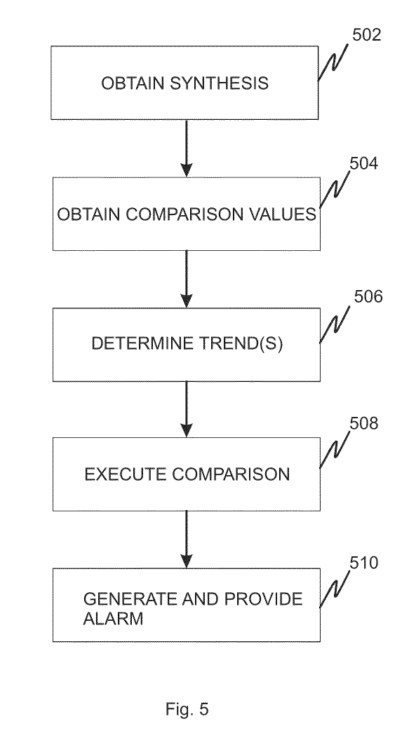

FIG. 5 is a flowchart of an embodiment for creating the alarm in accordance with the present invention. The method may be executed by an embodiment of the system disclosed herein. The method for creating an alarm is preferably part of the overall method of creating a synthesis as depicted in FIG. 4. The method for creating an alarm may take place e.g. after, or concurrently as, the synthesis is created (406).

At 502 a synthesis comprising textual and/or numerical information is obtained. Further values of interest, such as predetermined values pertaining to characteristics that may be used to deduce diagnoses, are preferably identified. Such characteristics may comprise weight, any type of heart rate, movement per time, blood pressure, caloric intake, SpO2, sleep cycles and quality thereof, blood sugar, and trends thereof, etc, with measured scalar values.

At 504 comparison values are obtained. The comparison values may be obtained as predetermined values for wellbeing characteristics or they may be obtained from a previously determined synthesis.

At 506 trends are determined on the basis of the synthesis. Detecting trends are known from the prior art and such means presented and used throughout various wellbeing and wearable devices.

At 508 the characteristic values identified at 502 are compared to the comparison values of 504, to determine if any of the identified characteristics are outside of predetermined comparison values or if a trend is suggesting an underlying or otherwise worsening outcome or condition. As said, being outside of typical values for these characteristics (known from the prior art of medical sciences) may imply various different conditions. E.g. continuous and prevailing rise in heart rate and/or blood pressure may be reasonably used to deduce a heart condition or a heightening risk for heart attack.

At 510 an alarm is created and provided to devices and users thereof. The alarm may be provided in or together with the synthesis to provide a reasoning for the alarm. In some instances the alarm may be comprise a signal to control or start a function in another device such as communicate with a medical alert system or with a medical device for giving aid to the individual to which the alert pertains to.

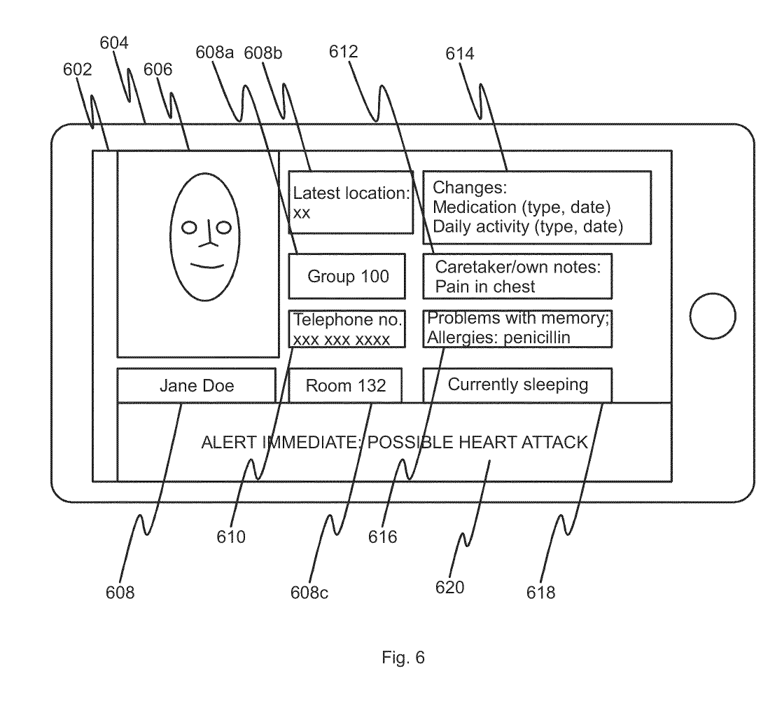

FIG. 6 is an illustration of a graphical user interface implemented embodiment of a synthesis and alarm thereof in accordance with the present invention.

The view depicts a GUI 602 implemented on a user computing device 604, such as a mobile device, reader, phablet, tablet, etc.

The feasible information components of the synthesis included herein are: a picture of the person to whom the synthesis pertains to 606, the name of said person 608, real-time and/or other location data 608a, 608b, 608c, telephone number 610, notes from caretaker and/or the person in question 612, recent changes 614, known problems/conditions/allergies 616 and current activity information 618.

As depicted also herein, many different parties and devices may provide their input, which is utilized by the system and the alarm. The synthesis preferably utilizes all available information in accordance with first, second, third, and fourth data and produces a readable report.

Herein the alarm 620 is presented as a visual function although the alarm may also be presented audibly. Herein the alarm informs that the person take care may have a heart attack risk—possibly at least partly due to the chest pains. Even further, in some embodiments the alarm may used to implement automatic actions, functions or control, such as to sound an alarm to a predetermined party, phone a predetermined location, send information, such as the synthesis or an emergency message to a predetermined party, or even in some instances control automatic care devices and/or emergency systems, such as a medical alert system. As mentioned also hereinbefore the alarm may constitute an alarm that needs immediate attention or an alarm, which doesn't need immediate attention. The alarms may hence be categorized and they may be provided correspondingly, such as that e.g. more slowly progressing diseases are only visually alarmed via synthesis whereas the more severe alarms are sent via many different means and/or to many different parties so that the alarm may be noticed immediately. The alarm may be however always reviewed or checked in light of the synthesis although in some instances the alarm may be produced from silent signals visible to the control entity via processing and comparison of the monitored sensor data and signals produced by at least the wellbeing devices.

The scope of the invention is determined by the attached claims together with the equivalents thereof. The skilled persons will again appreciate the fact that the explicitly disclosed embodiments were constructed for illustrative purposes only, and the scope will cover further embodiments, embodiment combinations and equivalents that better suit each particular use case of the invention.

1. A computer implemented system for creating a synthesis from numerical data and textual information relating to wellbeing of an individual comprising:
a control entity comprising a processing device, a memory device coupled to said processing device and at least means for obtaining and providing data, the control entity being further arranged to:
obtain first data comprising numerical information from at least one wellbeing device, which device is arranged to monitor said individual's at least one wellbeing characteristic,
obtain second data comprising free-form text in natural language format information, said information pertaining to the individual,
execute semantic analysis for the obtained second data comprising free-form text,
create a synthesis from said first data and the semantically analyzed second data,
compare at least the values of wellbeing characteristic in the first data or second data to predetermined threshold values or to a previously determined synthesis, optionally to determine a trend of said characteristics values,
generate an alarm if the generated synthesis comprises a number of wellbeing characteristics whose values are outside predetermined threshold values or outside previously determined synthesis values and/or if the trend of said characteristic values changes.

2. A system according to claim 1, wherein the system further comprises obtaining third data from one or more external measurement devices, which third data is also used in creating the synthesis.

3. A system according to claim 1, wherein the system further comprises obtaining fourth data from one or more external databases, which fourth data is also used in creating the synthesis.

4. A system according to claim 1, wherein said synthesis is provided in a textual form.

5. A system according to claim 1, wherein said second information is provided by a user, such as a caregiver.

6. A system according to claim 1, wherein a synthesis is created from data of a selectable or predetermined time period.

7. A system according to claim 1, wherein the synthesis comprises a reason for the alarm and/or implementable actions according to the reason of the alarm.

8. A computer implemented method for creating a synthesis from numerical data and textual information, comprising at least the following steps:
obtaining data in a numerical form,
obtaining data comprising free-form text in natural language format,
converting the data in a numerical form into a textual form,
semantically analyzing and/or formalizing said free-form text in natural language format,
creating a synthesis from said data in a numerical form and said semantically analyzed and/or formalized free-form text in natural language format,
providing said synthesis to a user and/or a device.

9. A method for creating a synthesis according to claim 8 comprising a further step of selecting a time period for the obtained data.

10. A computer program product embodied in a non-transitory computer readable carrier or distribution medium comprising computer instructions that, when run on a computer, cause the computer to execute the method of claim 8.
